(19) United States
(12) Patent Application Publication
(10) Pub. No.: US 2015/0363043 A1
(43) Pub. Date: Dec. 17, 2015

(54) TOUCH PANEL DEVICE AND TOUCH PANEL DEVICE CONTROL METHOD

(71) Applicant: Sharp Kabushiki Kaisha, Osaka-shi, Osaka (JP)

(72) Inventors: Kenichirou MIKAMI, Osaka-shi (JP); Shinichi YOSHIDA, Osaka-shi (JP); Masayuki YAMAGUCHI, Osaka-shi (JP); Michiaki TAKEDA, Osaka-shi (JP)

(73) Assignee: SHARP KABUSHIKI KAISHA, Osaka-shi, Osaka (JP)

(21) Appl. No.: 14/763,717

(22) PCT Filed: Jan. 9, 2014
(86) PCT No.: PCT/JP2014/050186

§ 371 Date: Jul. 27, 2015

(30) Foreign Application Priority Data
Jan. 30, 2013 (JP) 2013-016189

(51) Int. Cl. G06F 3/041; G06F 3/044

(52) U.S. Cl. CPC G06F 3/0418; G06F 3/0412; G06F 3/044; G06F 2203/04106

(57) ABSTRACT

A touch panel device (1) detecting a finger operation and a pen operation, the touch panel device includes: a touching object determining section (23) for determining whether or not a touch operation is the finger operation or the pen operation, depending on (a) whether or not a value outputted from a sensor is within a range indicated by a finger threshold value and (b) whether or not the value outputted from the sensor is within a range indicated by a pen threshold value, the touching object determining section (23) making no determination as to whether or not the touch operation in an Lp area is the pen operation but making a determination only as to whether or not the touch operation in the Lp area is the finger operation, depending on whether or not the value outputted from the sensor is in the range indicated by the finger threshold value.

### TECHNICAL FIELD

The present invention relates to a touch panel device which detects a touch operation with a finger and a touch operation with a pen, and a method of controlling the touch panel device, and a control program and a storage medium of the touch panel device.

### BACKGROUND ART

A touch sensor panel system has been used as a data input device in a variety of electronic devices such as portable phones, portable music players, portable game machines, TVs (Televisions), PCs (Personal Computers) and the like.

One detection method for such a touch panel system is a capacitive method according to which a change in electrostatic capacitance in accordance with a touch operation with a pen or a finger is detected. However, in conventional capacitive touch panel systems, only a touch operation with a finger or a touch operation with a pen can be detected by one touch panel system because the change in electrostatic capacitance largely differs depending on whether the touch operation is made with a finger or a pen.

In order to solve the above problem, there has been developed a technique for distinguishing between a touch operation with a finger and a touch operation with a pen by utilizing difference between (a) a change in electrostatic capacitance caused by an operation with a finger and (b) a change in electrostatic capacitance caused by a touch operation with a pen. For example, Patent Literature 1 discloses a touch panel device which (i) performs sensitivity correction in accordance with a position relative to an electrode which serves as a reference in detecting an electrostatic capacitance, (ii) determines that a touch operation is made with a finger in a case where a sensitivity obtained in the sensitivity correction is greater than a certain threshold value, whereas determining that the operation is made with a pen in a case where the sensitivity obtained in the sensitivity correction is lower than the threshold value.

### CITATION LIST

### Patent Literature

Patent Literature 1

Japanese Patent Application Publication, Tokukai, No. 2012-242989 (Publication Date: Dec. 10, 2012)

### SUMMARY OF INVENTION

### Technical Problem

As illustrated in FIG. 8, a touch panel device is provided with line sensors which detect a touch operation. The line sensors are provided so as to cover a liquid crystal display area (active area) of the touch panel device. As illustrated in FIG. 9, generally, a capacitance value caused by a contact with a finger is different from a capacitance value caused by a contact with a pen. It is possible to figure out whether a touch operation is made with a finger or a pen by utilizing the above difference.

However, in the vicinity of a bezel at an edge of a touch panel, in some cases, no line sensor is provided at a position where a finger or a pen touches the touch panel (a touched position is far from a sensor electrode). In such cases, a change in electrostatic capacitance caused by a touch operation with a finger or a touch operation with a pen is drastically reduced, as illustrated in FIG. 10.

FIG. 11 illustrates a relation between a position in an X-axis direction and a peak value of capacitance values which are caused by a finger operation and detected by the touch panel device at the position. As described above, a touch operation with a finger may not be detected in the vicinity of the bezel, because a capacitance value is lower in the vicinity of the bezel. More specifically, in an A-A′ area in the vicinity of the bezel as illustrated in FIG. 11, the touch panel device may erroneously recognize a finger operation as a pen operation. This is because in the A-A′ area, a finger signal is lower than a threshold value for finger operations but more than a threshold value for pen operations.

Further, for example, in a case where a touch operation with a finger is continuously made from a center area of the touch panel toward the vicinity of the bezel, the touch panel device erroneously recognizes that a finger operation is switched to a pen operation in the vicinity of the bezel. This leads to a problem that an interruption occurs during an input by a touch operation with a finger.

The present invention is attained in view of the above conventional problems. A main object of the present invention is to provide a touch panel device which detects both a touch operation with a finger and a touch operation with a pen and also prevents an erroneous recognition in an edge area of a touch panel, a method of controlling the touch panel device, and a control program and a storage medium of the touch panel device.

### Solution to Problem

In order to solve the above problems, a touch panel device in accordance with an aspect of the present invention is a touch panel device detecting a finger operation and a pen operation, the touch panel device including: a determination section for determining whether or not a touch operation is the finger operation or the pen operation, depending on (a) whether or not a value outputted from a sensor is within a range indicated by a finger threshold value and (b) whether or not the value outputted from the sensor is within a range indicated by a pen threshold value, for an Lp area where the value outputted from the sensor as a result of the finger operation is (i) not more than a lower limit value of the range indicated by the finger threshold value and (ii) not less than a lower limit value of the range indicated by the pen threshold value, the determination section making a determination as to whether or not the touch operation is the finger operation, depending on whether or not the value outputted from the sensor is in the range indicated by the finger threshold value.

In order to solve the above problems, a method in accordance with an aspect of the present invention for controlling a touch panel device is a method of controlling a touch panel device which detects a finger operation and a pen operation, the method including the step of: determining whether or not a touch operation is the finger operation or the pen operation, depending on (a) whether or not a value outputted from a sensor is within a range indicated by a finger threshold value and (b) whether or not the value outputted from the sensor is within a range indicated by a pen threshold value, wherein for an Lp area where the value outputted from the sensor as a result of the finger operation is (i) not more than a lower limit value of the range indicated by the finger threshold value and (ii) not less than a lower limit value of the range indicated by the pen threshold value, a determination is made as to whether or not the touch operation is the finger operation, depending on whether or not the value outputted from the sensor is in the range indicated by the finger threshold value.

### Advantages Effects of Invention

According to an aspect of the present invention, it is possible to prevent a finger operation from being misrecognized as a pen operation in an Lp area.

### BRIEF DESCRIPTION OF DRAWINGS

FIG. 1 is a block diagram illustrating a major configuration of a touch panel device, according to an embodiment of the present invention.

FIG. 2 is a graph showing a relation between a position in an X-axis direction (a horizontal direction of a panel) and a peak value of capacitance values which are caused by finger and pen operations and detected by a touch panel device at the position.

FIG. 3 is a view illustrating an example physical configuration of a touch panel.

FIG. 4 is a flowchart showing an example process performed by a touch panel device.

FIG. 5 is a diagram illustrating edge extending processing for correcting recognized coordinates.

FIG. 6 is a diagram illustrating an example in which edge extending processing is performed multiple times.

FIG. 7 is a diagram illustrating a method for converting a sensor coordinate system to a display coordinate system.

FIG. 8 is a diagram illustrating an arrangement of line sensors in a touch panel device, according to a conventional art.

FIG. 9 is graphs showing capacitance values caused by a finger operation and a pen operation in a center area of a touch panel, according to a conventional art.

FIG. 10 is graphs showing capacitance values caused by a finger operation and a pen operation in an edge area of a touch panel, according to a conventional art.

FIG. 11 is a graph showing a relation between a position in an X-axis direction (a horizontal direction of a panel) and a peak value of capacitance values which are caused by finger and pen operations and detected by a touch panel device at the position, according to a conventional art.

### DESCRIPTION OF EMBODIMENTS

### General Description of Invention

The present invention relates to a touch panel device which drives drive lines of a touch sensor panel so as to (i) detect an electrostatic capacitance value between each sensing line and each drive line and (ii) thereby identify a position where a touch operation is made on a screen. Concretely, line sensors are provided in parallel to each other so as to extend in a vertical direction, in an area larger than a display area of a touch panel.

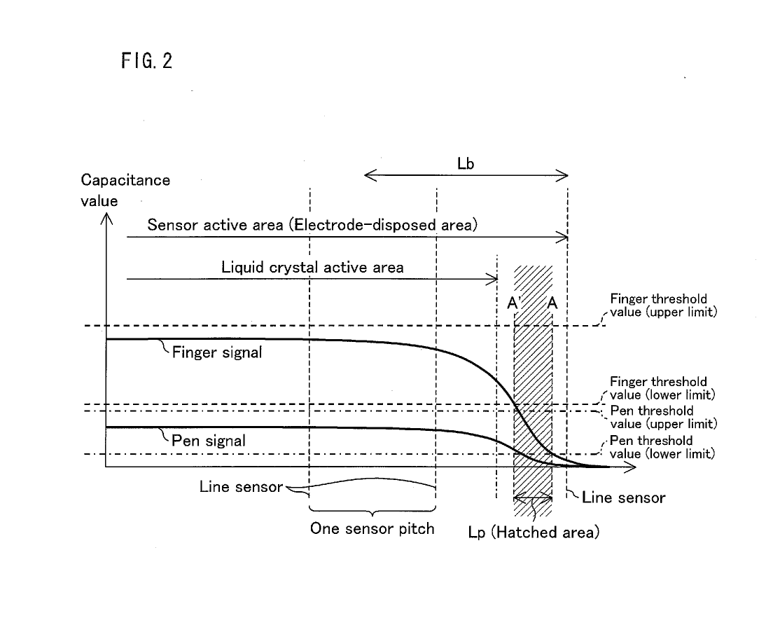

FIG. 2 shows a relation between a position in an X-axis direction (a horizontal direction of the panel) and a peak value of capacitance values which are caused by finger and pen operations and detected by the touch panel device at the position. In FIG. 2, an origin is a center of the touch panel device, and a right end of a graph corresponds to an edge of the touch panel device. Note that the graph of FIG. 2 is prepared by plotting, for example, values which occur when a ground-connected artificial finger and a ground-connected pen are caused to touch the touch panel.

As illustrated in FIG. 2, in the center area of the touch panel device, a capacitance value detected by the touch panel device differs depending on whether a touch operation is an operation made with a finger (finger operation) or an operation made with a pen (pen operation). Therefore, it is possible to distinguish between a finger operation and a pen operation by (i) measuring in advance a range of capacitance values to be detected by the touch panel device for each of (a) a case where a touch operation is made with a finger and (b) a case where a touch operation is made with a pen and (ii) setting threshold values on the basis of the ranges.

However, as illustrated in FIG. 2, the capacitance values to be detected by the touch panel device become lower in an edge area of a display. Therefore, there exists an area where the touch panel device erroneously recognizes a touch operation as a pen operation though in the reality the touch operation is made with a finger. Note that though FIG. 2 shows capacitance values only in the X-axis direction, capacitance values are similarly lower in an edge area in a Y-axis direction.

In the present invention, the area where a finger operation is erroneously recognized as a pen operation is called an Lp area. The Lp area is defined as an area extending from an intersection (A′) of a curve of a finger signal and a line of a lower-limit finger threshold value to an intersection (A) of the curve of the finger signal and a line of a lower-limit pen threshold value. Further, the Lp area is formed in a partial or whole area outside a liquid crystal active area and within a sensor active area.

For example, the Lp area is an area extending inward 1.9 mm (0.35 sensor pitch) from the outermost line sensor.

The present invention is intended to prevent a finger operation from being erroneously recognized as a pen operation. Concretely, according to the present invention, a finger threshold value and a pen threshold value are set for an area excluding the Lp area, so that the touch panel device detects the presence/absence of a finger operation and a pen operation in the area excluding the Lp area. Meanwhile, for the Lp area, no pen threshold value is set, so that the touch panel device detects only the presence/absence of a finger operation on the basis of the finger threshold value which is set for the area excluding the Lp area.

Therefore, in the present invention, as illustrated in FIG. 2, the touch panel device does not detect a pen operation in the Lp area even in a case where a pen signal corresponding to the pen operation is within a range indicated by pen threshold values which are set for the area excluding the Lp area. Further, the Lp area is an area where the finger signal is lower than the lower-limit finger threshold value. Therefore, in the Lp area, basically, no finger operation is detected because a capacitance value caused by a finger operation does not exceed the lower-limit finger threshold value.

In other words, in both the Lp area and an outside area on an outer side of the Lp area, basically, no touch operation is detected. This is taken into consideration, when a sensor coordinate system is conversed to a display coordinate system. Note that the sensor coordinate system provides coordinates indicative of a position of an intersection of a drive line and a sensing line, while the display coordinate system provides coordinates indicative of a position of a picture element.

Further, there occurs another problem that, in the edge area of the display, coordinates recognized by the touch panel device do not match a position where a touch operation is actually made, because a capacitance value to be detected by the touch panel device is lower in the edge area. Concretely, the coordinates detected by the touch panel device shift toward the center area of the display from the position where the touch operation is actually made.

In order to solve this problem, the present invention is further configured to correct coordinates detected by sensors in a predetermined area in the edge area of the display. As illustrated in FIG. 2, in the present invention, an area where a capacitance value to be detected by the touch panel device becomes lower is called an Lb area. In an example illustrated in FIG. 2, the Lb area is the same for both a finger operation and a pen operation. However, the Lb area for a finger operation and the Lb area for a pen operation can be differently set because the area where the capacitance value becomes lower differs between a finger operation and a pen operation. Note that the Lb area is an area where the capacitance value decreases to an extent that an amount of the above-described shift exceeds an acceptable value.

The following provides concrete embodiments and discusses in detail the present invention with reference to the embodiments.

### Embodiment 1

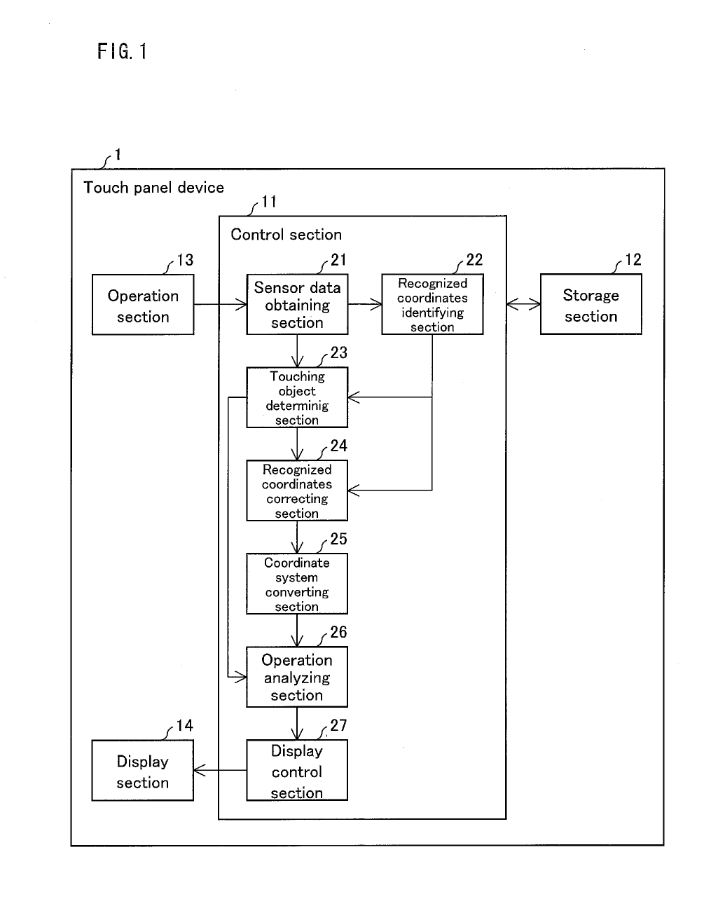

The following discusses an embodiment of the present invention, with reference to FIGS. 1 through 7.

<Configuration of Touch Panel Device>

FIG. 1 is a block diagram illustrating an example major configuration of a touch panel device 1. As illustrated in FIG. 1, the touch panel device 1 includes a control section 11, a storage section 12, an operation section 13, and a display section 14. Note that the touch panel device 1 can include members such as a communication section, a sound input section, and/or a sound output section. However, such members are irrelevant to features of the present invention and so, the members are not illustrated.

The touch panel device 1 is an electronic device where a touch panel is mounted. Examples of the electronic device encompass a portable phone, a smart phone, a portable music player, a TV, a PC, a digital camera, a digital video and the like.

The operation section 13 allows a user to input an instruction signal to the touch panel device 1 and thereby operate the touch panel device 1. In the present invention, the operation section 13 is a touch panel integrated with the display section 14.

The display section 14 displays an image in accordance with an instruction from the control section 11. The display section 14 can be any display as long as the display is capable of displaying an image in accordance with an instruction from the control section 11. Examples of such a display encompass an LCD (Liquid Crystal Display), an organic EL (electroluminescent) display, a plasma display and the like.

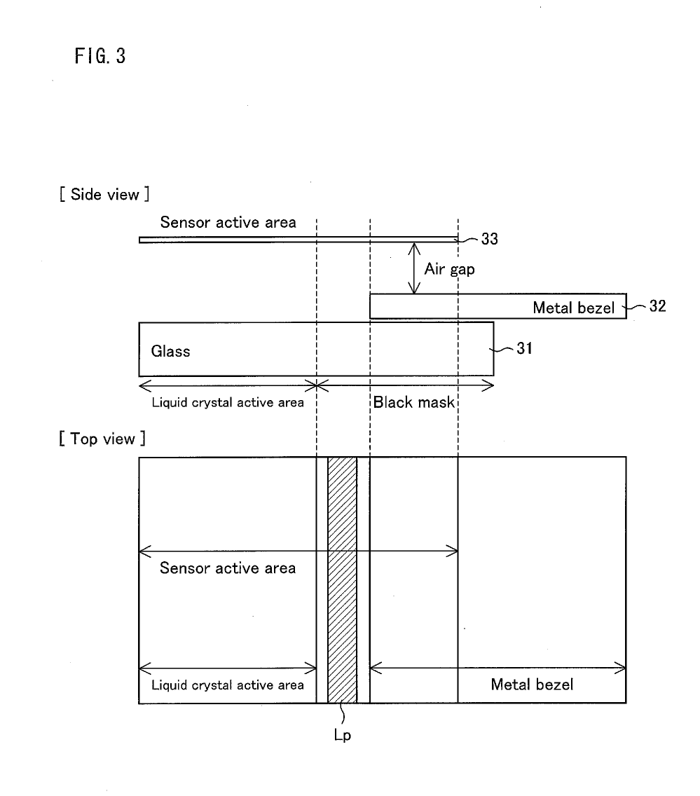

The following discusses physical configurations of the operation section 13 and the display section 14 with reference to FIG. 3. FIG. 3 is a schematic view illustrating an example physical configuration of the touch panel (the operation section 13 and the display section 14).

As illustrated in FIG. 3, most part of a glass 31 constituting the display section 14 is a liquid crystal active area. However, a periphery area of the glass 31 is a black mask area. On this black mask area of the glass 31, a metal bezel 32 is provided. Note that, as illustrated in FIG. 3, not all of the black mask area is covered with the metal bezel but a part of the black mask area is exposed. Note also that, in the example of FIG. 3, the black mask area is designed so as to be an area extending inward 0.5 sensor pitch from the outermost line sensor.

A sensor layer 33 constituting the operation section 13 is provided via an air gap above the glass 32 and the metal bezel 32. Therefore, as illustrated in FIG. 3, the sensor active area covers the liquid crystal active area and a part of the black mask area.

The control section 11 executes a program read out into a temporary storage section (not illustrated) from the storage section 12, so as to perform various operations and also to carry out overall control of each member of the touch panel device 1.

In the present embodiment, the control section 1 is configured to include, as functional blocks, a sensor data obtaining section 21, a recognized coordinates identifying section (recognized position identifying section) 22, a touching object determining section (determination section) 23, a recognized coordinates correcting section (recognized position correcting section) 24, a coordinate system converting section (display position specifying section) 25, an operation analyzing section 26, and a display control section 27. These function blocks 21 through 27 of the control section 11 can be realized with use of a CPU (central processing unit) by (i) reading out a program into a temporary storage section realized by an RAM (random access memory) or the like, which program is stored in a storage device realized by an ROM (read only memory) or the like, and (ii) executing the program.

The sensor data obtaining section 21 obtains sensor data from the operation section 13. Then, the sensor data obtaining section 21 outputs thus obtained sensor data to the recognized coordinates identifying section 22 and the touching object determining section 23. Note that the sensor data is data indicative of a capacitance value outputted by each line sensor.

The recognized coordinates identifying section 22 identifies recognized coordinates (recognized position) on the basis of the sensor data which has been obtained from the sensor data obtaining section 21. Then, the recognized coordinates identifying section 22 outputs thus identified recognized coordinates to the touching object determining section 23 and the recognized coordinates correcting section 24. The recognized coordinates here indicate a position in the sensor coordinate system which position is recognized by the touch panel device 1 at the time when a touch operation is made to the touch panel.

Concretely, for example, the recognized coordinates identifying section 22 may identify, as the recognized coordinates, a gravity center position on the basis of the sensor data. Alternatively, for example, the recognized coordinates identifying section 22 may subject the sensor data to fitting with a predetermined fitting curve and identify, as the recognized coordinates, a position of a peak value on the fitting curve. Note here that how to identify the recognized coordinates is not limited to the above-described examples but can be designed as appropriate.

In a case where the recognized coordinates identified by the recognized coordinates identifying section 22 are not in the Lp area, the touching object determining section 23 determines whether a touching object is a finger or a pen on the basis of the sensor data obtained from the sensor data obtaining section 21. Meanwhile, in a case where the recognized coordinates identified by the recognized coordinates identifying section 22 are in the Lp area, the touching object determining section 23 does not determine whether the touching object is a finger or a pen but determines only whether the touching object is a finger or not on the basis of the sensor data obtained from the sensor data obtaining section 21. Then, the touching object determining section 23 outputs a result of this determination to the recognized coordinates correcting section 24 and the operation analyzing section 26.

Concretely, for example, the touching object determining section 23 may determine that (a) the touching object is a finger in a case where a peak value of capacitance values indicated by the sensor data is within a range indicated by a finger threshold value (not less than a lower-limit finger threshold value and not more than an upper-limit finger threshold value) whereas (b) the touching object is a pen in a case where the peak value of capacitance values is within a range indicated by a pen threshold value (not less than a lower-limit pen threshold value and not more than an upper-limit pen threshold value). Alternatively, for example, the touching object determining section 23 may determine that (a) the touching object is a finger in a case where a value of integral of the capacitance values indicated by the sensor data is within the range of the finger threshold value (not less than the lower-limit finger threshold value and not more than the upper-limit finger threshold value) whereas (b) the touching object is a pen when the value of integral is within the range of the pen threshold value (not less than the lower-limit pen threshold value and not more than the upper-limit pen threshold value). Note that how to determine whether an operation is made with a finger or a pen is not limited to the above-described examples, but can be designed as appropriate. Note however that for the Lp area, the touching object determining section 23 is to determine the presence/absence of a finger operation on the basis of a finger threshold value which is used for an area excluding the Lp area.

In a case where the recognized coordinates identified by the recognized coordinates identifying section 22 are in the Lb area, the recognized coordinates correcting section 24 corrects the recognized coordinates identified by the recognized coordinates identifying section 22 so that the recognized coordinates match or approach an actually touched position. Then, the recognized coordinates correcting section 24 outputs thus corrected recognized coordinates to the coordinate system converting section 25. Note that a concrete method of such correction performed by the recognized coordinates correcting section 24 will be discussed later.

In a case where the recognized coordinates identified by the recognized coordinates identifying section 22 are not in the Lb area, the recognized coordinates correcting section 24 directly outputs, without making correction, the recognized coordinates identified by the recognized coordinates identifying section 22 to the coordinate system converting section 25.

The coordinate system converting section 25 obtains the recognized coordinates from the recognized coordinates correcting section 24, and convert thus obtained recognized coordinates in the sensor coordinate system to display coordinates (display position) in the display coordinate system. Then, the coordinate system converting section 25 outputs, to the operation analyzing section 26, thus converted display coordinates in the display coordinate system. Note that a concrete method of such coordinate conversion performed by the coordinate system converting section 25 will be discussed later.

The operation analyzing section 26 obtains (a) a determination result from the touching object determining section 23 and (b) the display coordinates in the display coordinate system from the coordinate system converting section 25. Then, the operation analyzing section 26 analyzes the operation made by a user on the basis of (a) a type of the touch operation (a finger operation or a pen operation) and (b) the display coordinates in the display coordinate system, so as to perform a process in accordance with the operation. In addition, the operation analyzing section 26 gives an instruction to the display control section 27 so that an image is displayed in accordance with thus performed process.

The display control section 27 generates an image in accordance with the instruction from the operation analyzing section 26, and then causes thus generated image to be displayed on the display section 14.

The storage section 12 stores programs, data, and the like which the control section 11 refers to. For example, the storage section 12 stores the finger threshold value, the pen threshold value, information indicative of the Lp area and the Lb area, and algorithms indicating a method of correcting coordinates and a method of converting a coordinate system, and the like.

[Example Process Performed by Touch Panel Device]

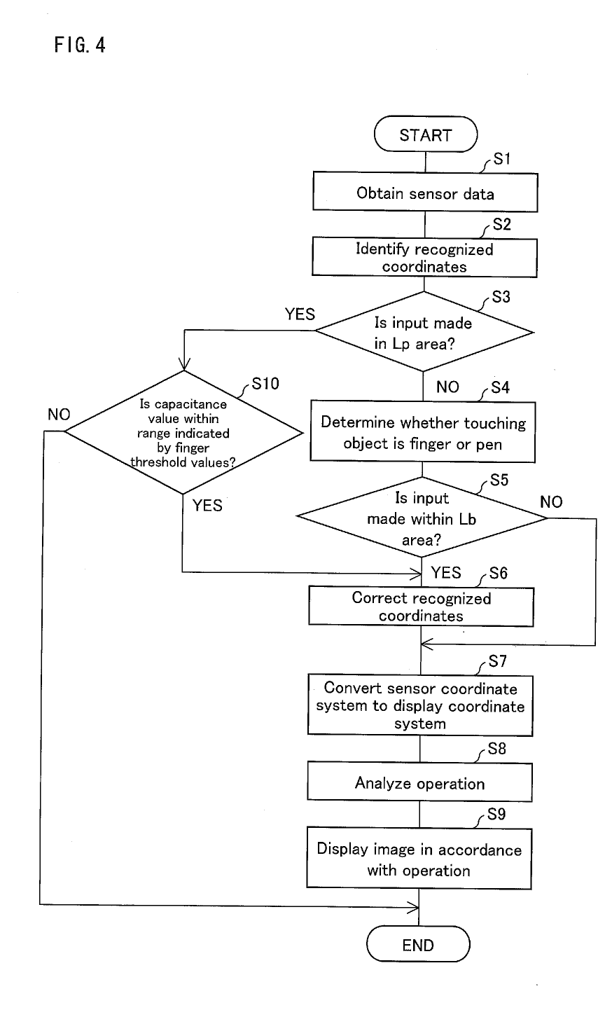

The following discusses one example process performed by the touch panel device 1, with reference to FIG. 4. FIG. 4 is a flowchart showing the example process performed by the touch panel device 1.

As shown in FIG. 4, first, the sensor data obtaining section 21 obtains sensor data from the operation section 13 (S2). Next, the recognized coordinates identifying section 22 identifies recognized coordinates on the basis of the sensor data obtained from the sensor data obtaining section 21 (S3).

Then, the touching object determining section 23 determines whether or not the recognized coordinates identified by the recognized coordinates identifying section 22 are in the Lp area (S3). In a case where the recognized coordinates identified by the recognized coordinates identifying section 22 are not in the Lp area (NO at S3), the touching object determining section 23 determines whether the touching object is a finger or a pen, on the basis of the sensor data obtained from the sensor data obtaining section 21 (S4).

Next, the recognized coordinates correcting section 24 determines whether or not the recognized coordinates identified by the recognized coordinates identifying section 22 are in the Lb area (S5). In a case where the recognized coordinates identified by the recognized coordinates identifying section 22 are in the Lb area (YES at S5), the recognized coordinates correcting section 24 corrects the recognized coordinates identified by the recognized coordinates identifying section 22 so that the recognized coordinates approach an actually touched position (S6). Meanwhile, in a case where the recognized coordinates identified by the recognized coordinates identifying section 22 are not in the Lb area (NO at S5), the recognized coordinates correcting section 24 directly outputs, without making correction, the recognized coordinates identified by the recognized coordinates identifying section 22 to the coordinate system converting section 25.

Obtaining the recognized coordinates from the recognized coordinates correcting section 24, the coordinate system converting section 25 converts the recognized coordinates in the sensor coordinate system to those in the display coordinate system, and thereby specifies display coordinates corresponding to the recognized coordinates obtained in the sensor coordinate system (S7).

Next, the operation analyzing section 26 obtains (a) a determination result from the touching object determining section 23 and (b) the display coordinates in the display coordinate system from the coordinate system converting section 25. Then, the operation analyzing section 26 analyzes an operation made by a user on the basis of (a) a type of a touch operation (a finger operation or a pen operation) and (b) the display coordinates in the display coordinate system, so as to perform a process in accordance with the operation (S8). In addition, the operation analyzing section 26 gives an instruction to the display control section 27 so that an image is displayed in accordance with thus performed process. The display control section 27 generates an image in accordance with the instruction from the operation analyzing section 26, and then causes thus generated image to be displayed on the display section 14 (S9).

In a case where the recognized coordinates identified by the recognized coordinates identifying section 22 are in the Lp area at S3 (YES at S3), the touching object determining section 23 determines whether or not the touching object is a finger, on the basis of the sensor data obtained from the sensor data obtaining section 21 (S10). In a case where the touching object determining section 23 determines that the touching object is a finger (YES at S10), the recognized coordinates correcting section 24 corrects the recognized coordinates identified by the recognized coordinates identifying section 22 so that the recognized coordinates approach the actually touched position (S6). The recognized coordinates correcting section 24 carries out the above correction because the Lp area is in the Lb area.

Meanwhile, in a case where the touching object determining section 23 determines that the touching object is not a finger (NO at S10), the control section 11 regards that no touch operation is made. Then, the control section 11 ends the process. Note that, as described above, in this case, a pen operation may have been made in the Lp area and the capacitance value may be within the range of the pen threshold value. However, such a touch operation is not determined as a pen operation but the pen operation having been made in the Lp area is made invalid.

[Correction Processing of Recognized Coordinates]

As described above, a finger signal and a pen signal become lower in the Lb area in the edge area of the display section 14. Therefore, in the Lb area, recognized coordinates do not match an actually touched position in the sensor coordinate system. Thus, it is necessary to correct the recognized coordinates identified in the Lb area by the recognized coordinates identifying section 22.

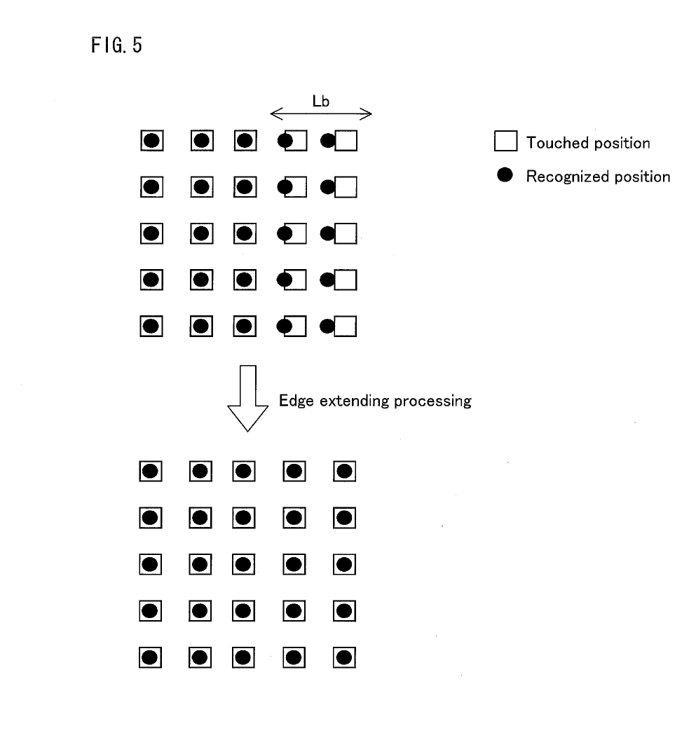

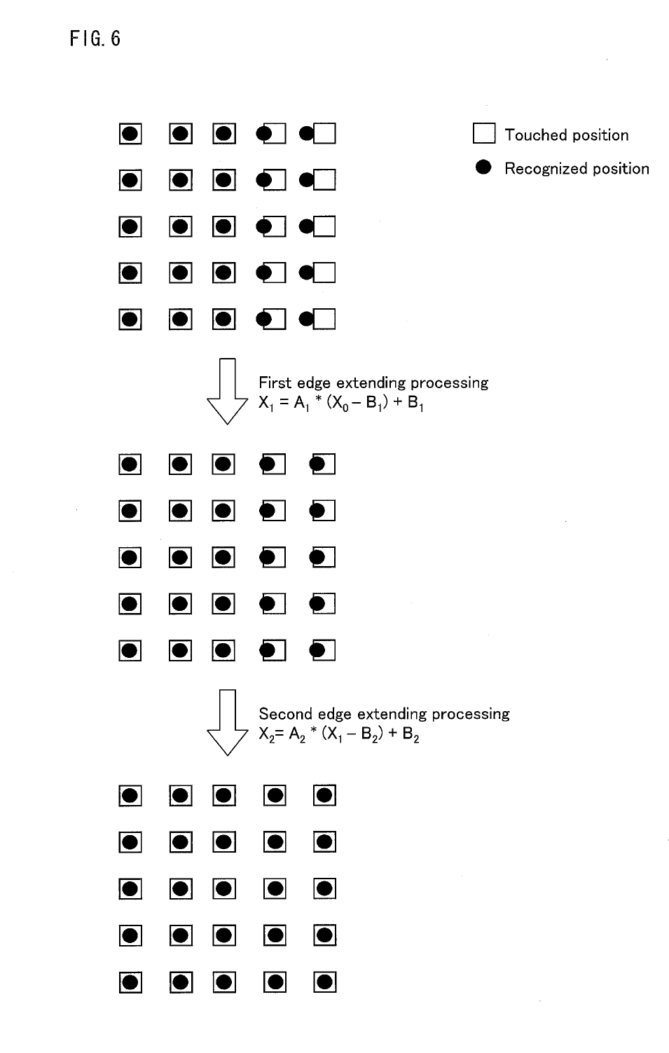

Next, the following discusses concrete correction processing (edge extending processing) performed by the recognized coordinates correcting section 24, with reference to FIGS. 5 and 6.

The recognized coordinates correcting section 24 subjects recognized coordinates (X₀, Y₀) identified by the recognized coordinates identifying section 22 to n times (n>0) of the edge extending processing in the X-axis direction and also to m times (m>0) of the edge extending processing in the Y-axis direction. Thereby, the recognized coordinates correcting section 24 calculates corrected recognized coordinates. The edge extending processing is performed according to the following formulae.

Xₙ=Aₙ*(Xₙ₋₁−Bₙ)+Bₙ

Yₘ=Cₘ*(Yₘ₋₁−Dₘ)+Dₘ

Here, (Xₙ, Yₘ) indicate recognized coordinates after the n-th edge extending processing in the X-axis direction and the m-th edge extending processing in the Y axis direction. While Aₙ and Bₙ are constants used in the n-th edge extending processing in the X-axis direction, Cₘ and Dₘ are constants used in the m-th edge extending processing in the Y-axis direction.

Note that prior to the edge extending processing, an actually touched position is given to the touch panel device 1 and accordingly, values of Aₙ, Bₙ, Cₘ and Dₘ, and the numbers of times (n, m) of the edge extending processing in the X-axis direction and the Y-axis direction are set.

As illustrated in FIG. 5, the recognized coordinates correcting section 24 subjects recognized coordinates in the Lb area to a predetermined number of times of the edge extending processing in the X-axis direction. Thereby, the recognized coordinates correcting section 24 corrects the recognized coordinates identified by the recognized coordinates identifying section 22 so that the recognized coordinates match or approach a position where a touch operation is actually made.

Values of A₁ to Aₙ, B₁ to Bₙ, C₁ to Cₘ, and D₁ to Dₘ do not have to be constant but can be different for each edge extending processing. In an example illustrated in FIG. 6, recognized coordinates are corrected by two times of the edge extending processing, and the values of Aₙ and Bₙ for the first edge extending processing differ from those for the second edge extending processing.

Note that parameters (the values of Aₙ, Bₙ, Cₘ and Dₘ, and the numbers of times of the edge extending processing in the X-axis direction and the Y-axis direction) should be set for each touch panel. Further, as in the above-described example, identical or different parameters can be used for each coordinate in the Lb area. Further, the parameters can be different depending on whether an operation is made with a finger or a pen.

[Coordinate System Conversion Processing]

As described above, no touch operation is basically detected in the Lp area and an outside area on an outer side of the Lp area. This should be taken into consideration in conversion from the sensor coordinate system to the display coordinate system.

The touch panel device 1 is assumed to include 101 line sensors arranged at regular intervals in the X-axis direction, and 101 drive lines arranged at regular intervals in the Y-axis direction. The 101 line sensors each are driven by the drive lines. In this case, a sensor coordinate system is (Xs, Ys) (0≦Xs≦100 and 0≦Ys≦100). Meanwhile, the display section 14 is made of a FHD (Full High Definition) display and a display coordinate is (Xd, Yd) (0≦Xd≦1919 and 0≦Yd≦1079).

Further, the Lp area and the outside area on the outer side of the Lp area mean an area extending inward 0.5 sensor pitch from the edge of the display section 14. In other words, the recognized coordinates which the coordinate system converting section 25 obtains from the recognized coordinates correcting section 24 basically have the following Xs and Ys ranges: 0.5≦Xs≦99.5 and 0.5≦Ys≦99.5.

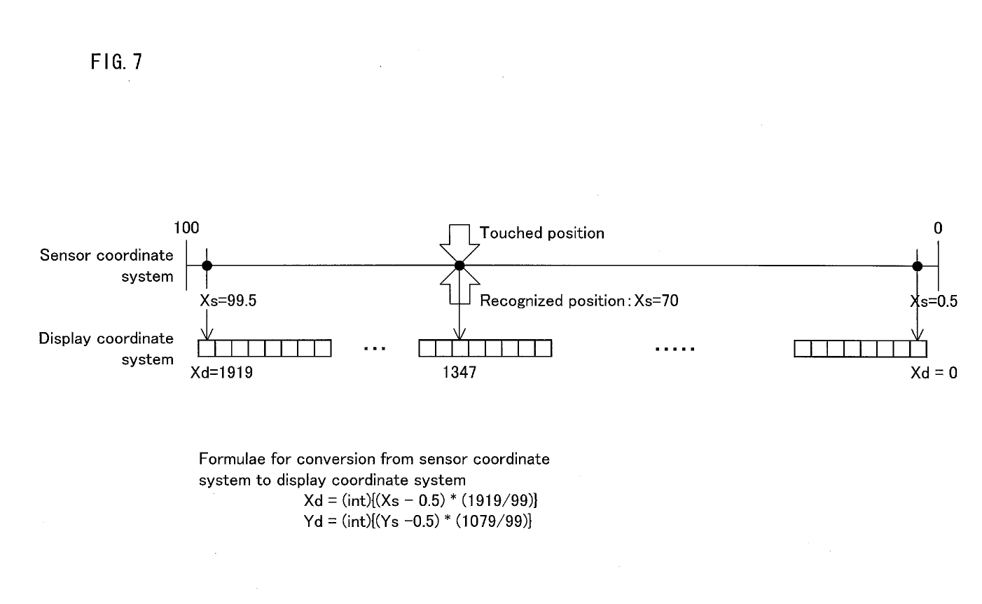

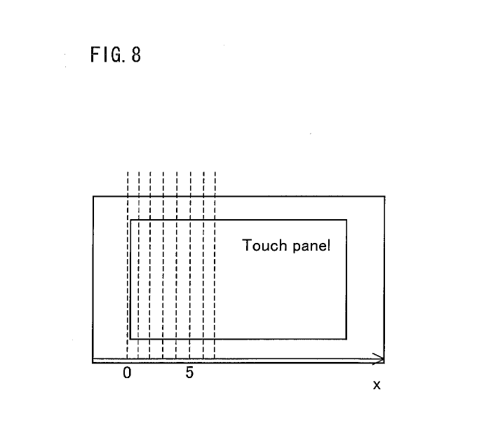

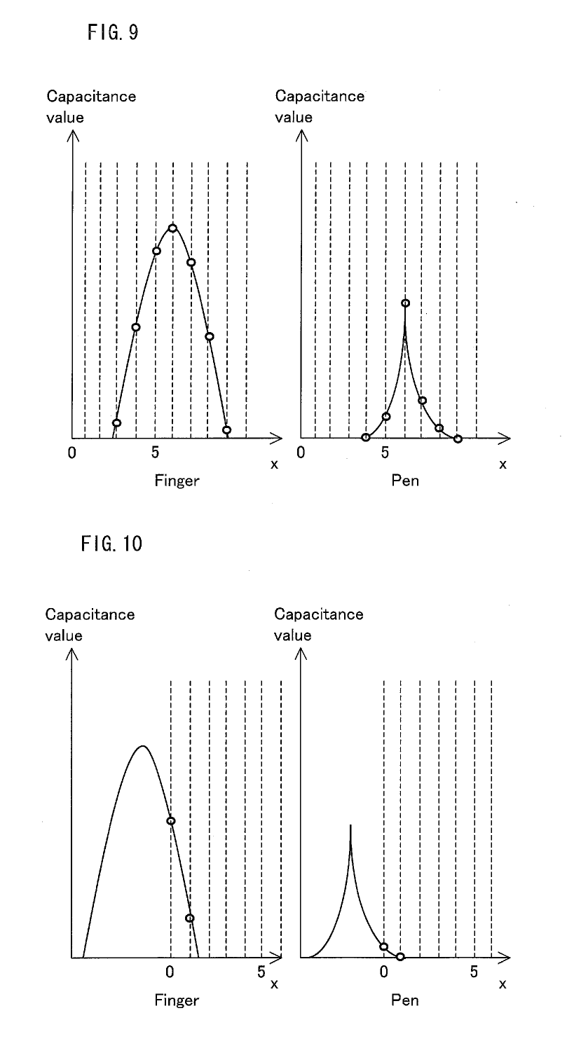

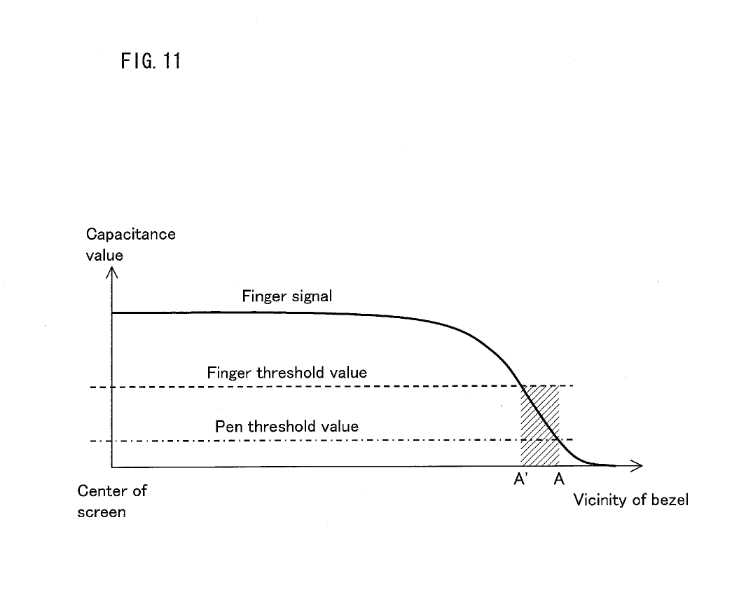

Accordingly, the coordinate system conversing section 25 regards that the recognized coordinates take the above values, and performs linear conversion into the display coordinate system as illustrated in FIG. 7. As shown in FIG. 7, concrete formulae for this conversion are:

Xd=(int){(Xn−0.5)*(1919/99)}

Yd=(int){(Ys−0.5)*(1079/99)}.

For example, as shown in FIG. 7, when Xs is 70, a corresponding display coordinate Xd is 1347.

Further, in a case where a finger operation or a pen operation is detected in the Lp area or the outside area on the outer side of the Lp area, the above formulae are not applied to recognized coordinates of thus detected finger operation or pen operation but the recognized coordinates are clipped. Concretely, when a recognized coordinate is less than 0.5 (Xs<0.5 and/or Ys<0.5), a corresponding display coordinate is set as Xd=0 and/or Yd=0. Meanwhile, when a recognized coordinate is more than 99.5 (Xs>99.5 and/or Ys>99.5), a corresponding display coordinate is set as Xd=1919 and/or Yd=1079.

### Embodiment 2

In the above Embodiment 1, one finger threshold value is used for detection of a finger operation regardless of whether or not a touched position is in an Lp area. However, the present invention is not limited to such a configuration. Embodiment 2 provides an example where a finger threshold value set for the Lp area is different from that for an area excluding the Lp area.

In Embodiment 2, a range indicated by the finger threshold value for the Lp area is set to be higher than a pen signal shown in FIG. 2 and lower than a finger signal shown in FIG. 2. Meanwhile, as in Embodiment 1, the pen threshold value is not set for the Lp area. By setting the finger threshold value for the Lp area as described above, it is possible to prevent a finger operation from being erroneously recognized in the Lp area as a pen operation.

### Embodiment 3

In Embodiment 1 described earlier, recognized coordinates are corrected by edge extending processing. However, the present invention is not limited to this configuration. Embodiment 3 discusses another example of correction processing for recognized coordinates.

In Embodiment 3, prior to the correction processing, a relation between (i) an actually touched position in a sensor coordinate system and (ii) recognized coordinates is measured, and a table showing the relation is prepared. Then, a recognized coordinates correcting section 24 corrects recognized coordinates identified by a recognized coordinates identifying section 22 on the basis of the table.

### Software Implementation Example

Control blocks of the touch panel device 1 (particularly, the control section 11) may be realized by a logic circuit (hardware) provided in an integrated circuit (IC chip) or the like or may be realized by software as executed by a CPU (Central Processing Unit).

In the latter case, the touch panel device 1 includes: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be made available to the computer via any transmission medium (such as a communication network and a broadcast wave) which enables transmission of the program. Note that the present invention can also be implemented by the program in the form of a computer data signal embedded in a carrier wave which is embodied by electronic transmission.

### CONCLUSION

A touch panel device according to Aspect 1 of the present invention is a touch panel device detecting a finger operation and a pen operation, the touch panel device including: a determination section for determining whether or not a touch operation is the finger operation or the pen operation, depending on (a) whether or not a value outputted from a sensor is within a range indicated by a finger threshold value and (b) whether or not the value outputted from the sensor is within a range indicated by a pen threshold value, for an Lp area where the value outputted from the sensor as a result of the finger operation is (i) not more than a lower limit value of the range indicated by the finger threshold value and (ii) not less than a lower limit value of the range indicated by the pen threshold value, the determination section making no determination as to whether or not the touch operation is the pen operation but making a determination only as to whether or not the touch operation is the finger operation, depending on whether or not the value outputted from the sensor is in the range indicated by the finger threshold value.

In the Lp area, a value outputted from the sensor as a result of a finger operation is (i) not more than the lower limit value of the range indicated by the finger threshold value and (ii) not less than the lower limit value of the range indicated by the pen threshold value. Therefore, when a conventional detection on the basis of the pen threshold is carried out, the touch panel device may erroneously recognize a finger operation as a pen operation.

According to the above configuration, for the Lp area, the determination section does not make a determination as to whether or not a touch operation is a pen operation but determines only whether or not the touch operation is a finger operation. In other words, in the Lp area, no pen operation is detected, but only a finger operation is detected. As a result, in the Lp area, it is possible to prevent a finger operation from being erroneously recognized as a pen operation.

A touch panel device according to Aspect 2 of the present invention can be configured to further include: a recognized position identifying section for identifying a recognized position in a sensor coordinate system, on the basis of the value outputted from the sensor; and a display position specifying section for specifying a display position corresponding to the recognized position, by subjecting the recognized position in an area excluding the Lp area to linear conversion from the sensor coordinate system to a display coordinate system, in addition to Aspect 1.

In the Lp area, neither a pen operation nor a finger operation is detected because a value outputted from the sensor as a result of a finger operation is not more than the lower limit value of the range indicated by the finger threshold value. Therefore, it is necessary to convert a recognized position in the sensor coordinate system to that in the display coordinate system, so as to complement the Lp area.

According to the above configuration, the display position specifying section performs linear conversion from the sensor coordinate system in an area excluding the Lp area to the display coordinate system, and specifies a display position corresponding to the recognized position. Therefore, it is possible to appropriately specify a relation between a recognized position which the sensor can detect and a display position.

A touch panel device according to Aspect 3 of the present invention can be configured to further include, in addition to Embodiment 2, a recognized position correcting section for correcting the recognized position so that the recognized position approaches an actually touched position, in a case where the recognized position is in an Lb area where the value outputted from the sensor decreases, the recognized position having been identified by the recognized position identifying section.

In the Lb area, a value outputted from the sensor becomes lower. Therefore, a recognized position specified by the operation position specifying section does not match an actually touched position.

According to the above configuration, the recognized position correcting section corrects the recognized position so that the recognized position approaches the actually touched position. Therefore, the recognized position can be caused to match or approach the actually touched position.

A touch panel device according to Aspect 4 of the present invention can be configured such that in Aspect 3, the recognized position correcting section subjects recognized coordinates (X₀, Y₀) identified by the recognized position identifying section to n times of edge extending processing in an X-axis direction and m times of edge extending processing in a Y-axis direction so as to correct the recognized coordinates, the edge extending processing in the X-axis direction and the edge extending processing in the Y-axis direction being carried out by using the following formulae, respectively:

Xₙ=Aₙ*(Xₙ₋₁−Bₙ)+Bₙ

Yₘ=Cₘ*(Yₘ₋₁−Dₘ)+Dₘ

Xₙ: an X coordinate after n-th edge extending processing in the X-axis direction

Yₘ: a Y coordinate after m-th edge extending processing in the Y-axis direction

Aₙ and Bₙ: constants used for the n-th edge extending processing in the X-axis direction

Cₘ and Dₘ: constants used for the m-th edge extending processing in the Y-axis direction.

A method according to Aspect 5 of the present invention for controlling a touch panel device is a method of controlling a touch panel device which detects a finger operation and a pen operation, the method including the step of: determining whether or not a touch operation is the finger operation or the pen operation, depending on (a) whether or not a value outputted from a sensor is within a range indicated by a finger threshold value and (b) whether or not the value outputted from the sensor is within a range indicated by a pen threshold value, wherein for an Lp area where the value outputted from the sensor as a result of the finger operation is (i) not more than a lower limit value of the range indicated by the finger threshold value and (ii) not less than a lower limit value of the range indicated by the pen threshold value, no determination is made as to whether or not the touch operation is the pen operation but a determination is made only as to whether or not the touch operation is the finger operation, depending on whether or not the value outputted from the sensor is in the range indicated by the finger threshold value.

The touch panel device according to each of the above aspects of the present invention can be realized by a computer. In this case, the present invention encompasses (a) a control program of the touch panel device which control program realizes the touch panel device by a computer by causing the computer to operate as each section provided in the touch panel device and (b) a computer-readable storage medium in which the control program is stored.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can be used as a touch panel device which can be operated with a finger or a pen.

### REFERENCE SIGNS LIST

1 Touch panel device
11 Control section
13 Operation section
14 Display section
21 Sensor data obtaining section
22 Recognized coordinates identifying section (recognized position identifying section)
23 Touching object determining section (determination section)
24 Recognized coordinates correcting section (recognized position correcting section)
25 Coordinate system converting section (display position specifying section)
26 Operation analyzing section
27 Display control section

1. A touch panel device detecting a finger operation and a pen operation, the touch panel device comprising:
a determination section for determining whether or not a touch operation is the finger operation or the pen operation, depending on (a) whether or not a value outputted from a sensor is within a range indicated by a finger threshold value and (b) whether or not the value outputted from the sensor is within a range indicated by a pen threshold value,
for an Lp area where the value outputted from the sensor as a result of the finger operation is (i) not more than a lower limit value of the range indicated by the finger threshold value and (ii) not less than a lower limit value of the range indicated by the pen threshold value, the determination section making no determination as to whether or not the touch operation is the pen operation but making a determination only as to whether or not the touch operation is the finger operation, depending on whether or not the value outputted from the sensor is in the range indicated by the finger threshold value.

2. The touch panel device as set forth in claim 1, further comprising:
a recognized position identifying section for identifying a recognized position in a sensor coordinate system, on the basis of the value outputted from the sensor; and
a display position specifying section for specifying a display position corresponding to the recognized position, by subjecting the recognized position in an area excluding the Lp area to linear conversion from the sensor coordinate system to a display coordinate system.

3. The touch panel device as set forth in claim 2, further comprising a recognized position correcting section for correcting the recognized position so that the recognized position approaches an actually touched position, in a case where the recognized position is in an Lb area where the value outputted from the sensor decreases, the recognized position having been identified by the recognized position identifying section.

4. The touch panel device as set forth in claim 3, wherein the recognized position correcting section subjects recognized coordinates (X₀, Y₀) identified by the recognized position identifying section to n times of edge extending processing in an X-axis direction and m times of edge extending processing in a Y-axis direction so as to correct the recognized coordinates, the edge extending processing in the X-axis direction and the edge extending processing in the Y-axis direction being carried out by using the following formulae:
Xₙ=Aₙ*(Xₙ₋₁−Bₙ)+Bₙ
Yₘ=Cₘ*(Yₘ₋₁−Dₘ)+Dₘ
Xₙ: an X coordinate after n-th edge extending processing in the X-axis direction
Yₘ: a Y coordinate after m-th edge extending processing in the Y-axis direction
Aₙ and Bₙ: constants used for the n-th edge extending processing in the X-axis direction
Cₘ and Dₘ: constants used for the m-th edge extending processing in the Y-axis direction.

5. A method of controlling a touch panel device which detects a finger operation and a pen operation, the method comprising the step of:
determining whether or not a touch operation is the finger operation or the pen operation, depending on (a) whether or not a value outputted from a sensor is within a range indicated by a finger threshold value and (b) whether or not the value outputted from the sensor is within a range indicated by a pen threshold value,
wherein for an Lp area where the value outputted from the sensor as a result of the finger operation is (i) not more than a lower limit value of the range indicated by the finger threshold value and (ii) not less than a lower limit value of the range indicated by the pen threshold value, no determination is made as to whether or not the touch operation is the pen operation but a determination is made only as to whether or not the touch operation is the finger operation, depending on whether or not the value outputted from the sensor is in the range indicated by the finger threshold value.
